(19) United States
(12) Patent Application Publication
(10) Pub. No.: US 2026/0285383 A1
(43) Pub. Date: Sep. 24, 2026

(54) Touch-Free Laundry Bin Device

(71) Applicant: Rene Dandrea, Highland Lakes, NJ (US)

(72) Inventor: Rene Dandrea, Highland Lakes, NJ (US)

(21) Appl. No.: 19/206,715

(22) Filed: May 13, 2025

Related U.S. Application Data
(60) Provisional application No. 63/774,403, filed on Mar. 19, 2025.

(51) Int. Cl. B62B 3/00; B62B 3/10; B62B 5/00; B62B 5/06; D06F 95/00

(52) U.S. Cl. CPC B62B 3/004; B62B 3/106; B62B 5/06; D06F 95/004; B62B 5/0013; B62B 2202/66; B62B 2301/04; B62B 2301/25

(57) ABSTRACT

A touch-free laundry bin device is provided and is designed for hospitals and healthcare facilities to ensure hygienic handling of soiled linens while minimizing the risk of injuries and cross-contamination. The device comprises an inner frame attached to an outer frame. A laundry bag with an attachment fastener is secured to the outer frame. The outer frame includes at least one wheel and a handle. All components may further be covered in an antimicrobial coating. A lid of the device is attached to the inner frame via a motorized hinge and is controlled by sensors, such as motion or foot-activated sensors, ensuring hands-free operation. A secondary sensor beneath the lid keeps it open while laundry is being loaded.

### CROSS-REFERENCE TO RELATED APPLICATION

The present application claims priority to, and the benefit of, U.S. Provisional Application No. 63/774,403, which was filed on Mar. 19, 2025, and is incorporated herein by reference in its entirety.

### FIELD OF THE INVENTION

The present invention relates generally to the field of laundry containers. More specifically, the present invention relates to a touch-free laundry bin device designed for hospitals and healthcare facilities to ensure hygienic handling of soiled linens while minimizing the risk of injuries and cross-contamination. Accordingly, the present disclosure makes specific reference thereto. Nonetheless, it is to be appreciated that aspects of the present invention are also equally applicable to other like applications, devices, and methods of manufacture.

### BACKGROUND

Laundry storage bins are commonly used in hospitals and other medical facilities to contain soiled linens and prevent contamination and the spread of odors. These bins typically feature lids to maintain hygiene and ensure compliance with sanitation standards. While lids effectively contain odors and reduce contamination risks, they also create operational challenges. In many cases, the lid must be manually opened, which increases the risk of cross-contamination as users must touch the bin before and after handling linens. Additionally, manual lids may unexpectedly close, potentially injuring the user's hands or disrupting the disposal process. This issue is particularly problematic in fast-paced medical environments where efficiency and safety are paramount. Traditional bins with basic lid mechanisms require additional time and effort from healthcare workers, which can reduce productivity. Furthermore, these limitations contribute to ergonomic strain, as users may need to bend or maneuver awkwardly to dispose of laundry safely. Given the importance of hygiene, efficiency, and user safety in medical settings, there is a need for an improved laundry bin that minimizes physical contact and enhances operational convenience.

Therefore, there exists a long-felt need in the art for a touch-free laundry storage device that eliminates odor and contamination. There also exists a long-felt need in the art for a touch-free laundry storage device that incorporates sensors to prevent the lid from closing on an individual's hands. Moreover, there exists a long-felt need in the art for a touch-free laundry storage device that improves user safety and efficiency in medical and high-risk environments.

The subject matter disclosed and claimed herein, in one embodiment thereof, comprises a touch-free laundry bin device. The device is comprised of a touch-free laundry bin device designed for hospitals and healthcare facilities to ensure hygienic handling of soiled linens while minimizing the risk of injuries and cross-contamination. The device comprises an inner frame attached to an outer frame. A laundry bag with an attachment fastener is secured to the outer frame. The outer frame includes at least one wheel and a handle. All components may further be covered in an antimicrobial coating. A lid of the device is attached to the inner frame via a motorized hinge and is controlled by sensors, such as motion or foot-activated sensors, ensuring hands-free operation. A secondary sensor beneath the lid keeps it open while laundry is being loaded. A manual override switch allows emergency operation, and the system is powered by a battery with a charging port and status indicator. A method of use includes providing the device, securing a laundry bag, the automatic lid opening upon user approach, placing soiled linens inside the laundry bag, and the automatic closure of the lid after use.

In this manner, the touch-free laundry bin device of the present invention accomplishes all the foregoing objectives and provides an automated, hands-free linen disposal system that enhances hygiene and safety in healthcare settings. More specifically, the motorized lid eliminates the need for manual contact and reduces the risk of contamination. The secondary sensor further ensures that the lid remains open while laundry is being loaded, preventing accidental closures that could cause injury or disruption. The inclusion of antimicrobial coatings further enhances the device's suitability for medical environments by reducing bacterial and viral contamination. By integrating advanced sensor technology, ergonomic design, and hygienic materials, the device significantly improves upon traditional laundry storage solutions in hospitals and other medical facilities.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a touch-free laundry bin device. The touch-free laundry bin device is an automated, hands-free system designed for hospitals and healthcare facilities to ensure safe and hygienic handling of soiled linens while minimizing injury risks and cross-contamination.

The device is comprised of an inner frame and an outer frame, which in one embodiment is movably attached to allow manual sliding or articulation for easy access to laundry bags. The outer frame includes at least one wheel. The outer frame also features a handle with a textured grip area made from non-slip materials. An antimicrobial coating may be applied to all components to reduce bacterial and viral contamination.

At least one lid is attached to the outer frame via at least one hinge, preferably a motorized hinge. A sensor detects a user's presence and opens the lid automatically. A second sensor on the underside of the lid ensures the lid remains open while laundry is being loaded, preventing accidental closures. The lid then closes gently and quietly once the user steps away.

The hinge and sensors are powered by at least one battery, which may be disposable or rechargeable. In a rechargeable embodiment, a charging port with a waterproof cover for protection. A battery status indicator on the outer frame displays the current charge level. Additionally, a paper towel holder is incorporated for easy access to cleaning materials.

A method of using the device involves placing a laundry bag inside, where it is secured by a raised lip or attachment fastener. A sensor detects user presence and automatically opens the lid via the motorized hinge. The second sensor ensures the lid remains open while linens are being loaded. Once the user steps away, the lid closes automatically. When the laundry bag is full, the outer frame may be manually slid or articulated for easy removal.

Accordingly, the touch-free laundry bin device of the present invention is particularly advantageous as it provides an automated, hands-free linen disposal system that enhances hygiene and safety in healthcare settings. More specifically, the motorized lid eliminates the need for manual contact and reduces the risk of contamination. The secondary sensor further ensures that the lid remains open while laundry is being loaded, preventing accidental closures that could cause injury or disruption. The inclusion of antimicrobial coatings further enhances the device's suitability for medical environments by reducing bacterial and viral contamination. By integrating advanced sensor technology, ergonomic design, and hygienic materials, the device significantly improves upon traditional laundry storage solutions in hospitals and other medical facilities. In this manner, the touch-free laundry bin device overcomes the limitations of existing laundry bins and methods of use known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a touch-free laundry bin device of the present invention with a closed lid and laundry bag attached in accordance with the disclosed architecture;

FIG. 2 illustrates a perspective view of one potential embodiment of a touch-free laundry bin device of the present invention with an open lid in accordance with the disclosed architecture;

FIG. 3 illustrates a perspective view of one potential embodiment of a touch-free laundry bin device of the present invention with an open lid and laundry bag attached in accordance with the disclosed architecture; and

FIG. 4 illustrates a flowchart of a method of using one potential embodiment of a touch-free laundry bin device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a touch-free laundry storage device that eliminates odor and contamination. There also exists a long-felt need in the art for a touch-free laundry storage device that incorporates sensors to prevent the lid from closing on an individual's hands. Moreover, there exists a long-felt need in the art for a touch-free laundry storage device that improves user safety and efficiency in medical and high-risk environments.

The present invention, in one exemplary embodiment, is comprised of a touch-free laundry bin device. The touch-free laundry bin device is an automated, hands-free system designed for hospitals and healthcare facilities to promote safe and hygienic handling of soiled linens while reducing the risk of injuries and cross-contamination.

The device is comprised of an inner frame and an outer frame, which in one embodiment is movably attached to allow manual sliding or articulation for convenient access to laundry bags. The outer frame incorporates at least one wheel and features a handle with a textured grip area made from non-slip materials. An antimicrobial coating may be applied to all components to help minimize bacterial and viral contamination.

At least one lid is secured to the outer frame via at least one hinge, preferably a motorized hinge. A sensor detects user presence and automatically opens the lid. A second sensor positioned on the underside of the lid ensures the lid remains open while laundry is being loaded, preventing accidental closures. Once the user steps away, the lid gently and quietly closes.

The hinge and sensors are powered by at least one battery, which may be either disposable or rechargeable. In a rechargeable configuration, a charging port is included with a waterproof cover for protection. A battery status indicator on the outer frame provides a visual display of the current charge level. Additionally, a paper towel holder is integrated for convenient access to cleaning materials.

The method of using the device includes placing a laundry bag inside, where it is secured by a raised lip or attachment fastener. A sensor detects user presence and activates the motorized hinge to open the lid automatically. The second sensor ensures the lid remains open while linens are being loaded. After the user steps away, the lid closes automatically. When the laundry bag is full, the outer frame may be manually slid or articulated for easy removal.

Therefore, the touch-free laundry bin device provides a highly effective automated linen disposal system that enhances hygiene and safety in healthcare environments. The motorized lid eliminates manual contact, reducing the risk of contamination, while the secondary sensor prevents accidental closures during loading. The antimicrobial coating further improves the device's suitability for medical settings by minimizing bacterial and viral contamination. By integrating advanced sensor technology, an ergonomic design, and hygienic materials, the device offers a significant improvement over traditional laundry storage solutions in hospitals and other medical facilities. In this way, the touch-free laundry bin device overcomes the limitations of existing laundry bins and disposal methods known in the art.

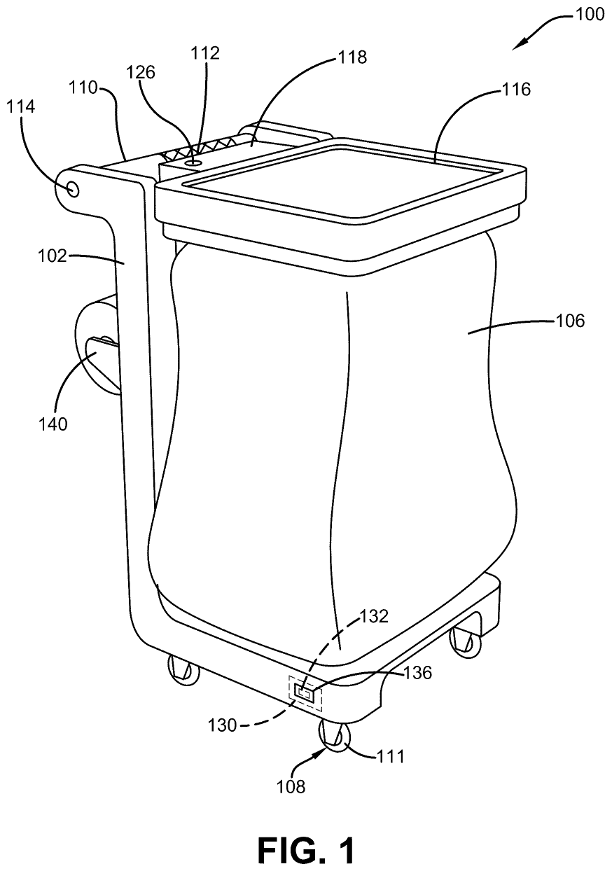

Referring initially to the drawings, FIG. 1 illustrates a perspective view of one potential embodiment of a touch-free laundry bin device 100 of the present invention with a closed lid 116 and laundry bag 106 attached in accordance with the disclosed architecture. The touch-free laundry bin device 100 is an automated, hands-free laundry disposal system designed for hospitals and healthcare facilities that ensures a safe and hygienic way to handle soiled linens while reducing the risk of injuries and cross-contamination.

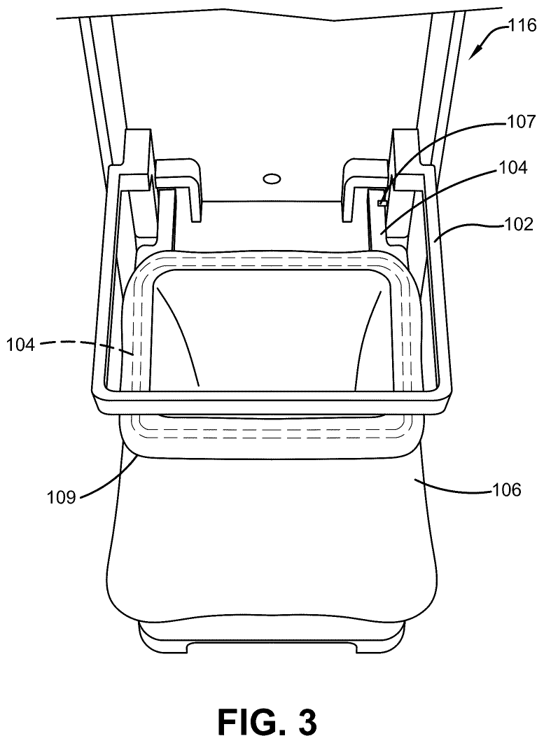

More specifically, the device 100 is comprised of an inner frame 102 and an outer frame 104 that may be movably attached to the inner frame 102 in one embodiment, wherein in this embodiment the outer frame 104 can be manually slid or articulated to allow users to easily access and remove full laundry bags 106 without unnecessary strain. In one embodiment, a locking mechanism 107 secures the outer frame 104 in the raised position as seen in FIG. 3, preventing accidental drops and ensuring user safety. The laundry bag 106 may be further comprised of an attachment fastener 109, such as, but not limited to, a raised lip, that sits atop the outer frame 104 (as seen in FIG. 1 and FIG. 3), securing the bag 106 in place and preventing the bag 106 from slipping into the bin during use. However, it should be noted that the fastener 109 may be other structures, such as clips, clamps, etc., that allows for attachment to the frame 104.

The outer frame 104 is further comprised of at least one wheel 108. The wheel 108 is preferably, but not limited to, a locking caster wheel. However, the wheel 108 may be any type of wheel, such as, but not limited to, omnidirectional wheels, swivel wheels, or medical-grade wheels designed for smooth movement over various floor surfaces. Additionally, the wheel 108 may feature a non-marking rubberized tread 111 to prevent floor damage and ensure quiet operation in hospital environments.

The outer frame 104 is comprised of a handle 110. The handle 110 may be comprised of a textured grip area 112. The textured grip area 112 may be textured with ergonomic ridges or patterned indentations for enhanced grip and comfort. The grip area 112 is preferably made from a non-slip grip material such as, but not limited to, rubberized coatings, silicone-based materials, or thermoplastic elastomers. In one embodiment, the grip area 112 is covered and made from a cushioned, shock-absorbing material to reduce hand fatigue during extended use. In another embodiment, the grip area 112 features a grooved pattern to improve grip security, particularly when operated with gloved hands in medical settings. The handle 110 may also be contoured to accommodate different hand sizes and provide a more natural gripping position. All components of the device 100 may also be covered in an antimicrobial coating 114 to reduce bacterial and viral contamination.

At least one lid 116 attaches to the outer frame 104 via at least one hinge 118. In the preferred embodiment, the hinge 118 is a motorized hinge. In this embodiment, at least one sensor 120, such as, but not limited to, a motion sensor, opens the lid 116. In alternative embodiments, the sensor 120 may be an infrared proximity sensor, a capacitive touch sensor, or a pressure sensor embedded in a foot pedal area, allowing activation through different user interactions. In one embodiment, the sensor 120 is placed near the bottom of the device 100 for foot activation.

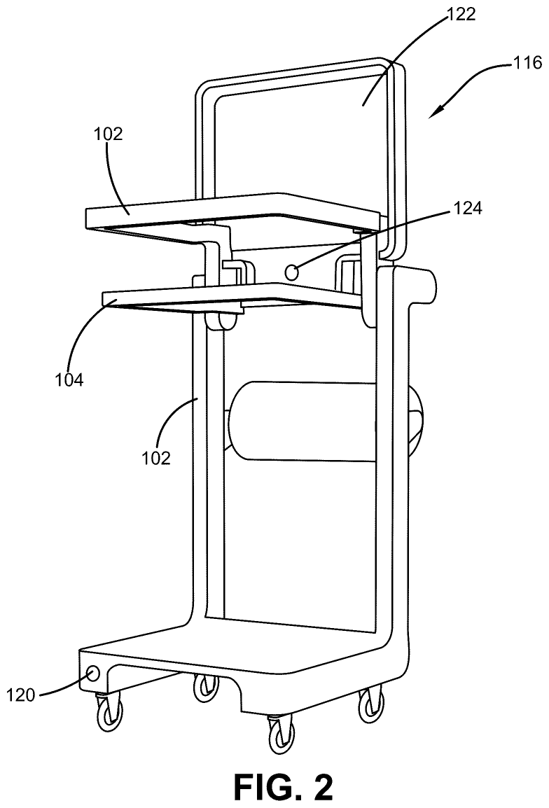

A bottom surface 122 of the lid 116 is further comprised of a second sensor 124 as seen in FIG. 2, such as, but not limited to, a motion sensor, that ensures the lid 116 remains open while laundry is being loaded into the bag 106 secured by the outer frame 104, preventing accidental closures that could lead to injury or frustration. In another embodiment, the second sensor 124 may be an ultrasonic sensor, detecting the presence of objects beneath the lid 116 to maintain an open position. In yet another embodiment, the sensor 124 is a time-of-flight (ToF) sensor that measures distance changes and adjusts lid 116 operation accordingly.

Once the user steps away, the lid 116 gently and quietly closes via the hinge 118. An emergency manual override switch 126 is incorporated near the base of the device 100, allowing manual operation in case of power failure or sensor malfunction.

The hinge 118 and sensors 120, 124 are powered by at least one battery 130, as seen in FIG. 1. The battery 130 may be disposable or rechargeable. In a rechargeable embodiment, the battery 130 may be comprised of at least one charging port 132, such as, but not limited to, a USB-C port or a magnetic charging interface. The charging port 132 and/or battery 130 may be protected by a waterproof cover 134. A battery status indicator 136 is positioned on the outer frame 104 to display the current charge level and notify users when recharging is required. Additionally, the device 100 is comprised of a paper towel holder 140 for easy access to cleaning materials.

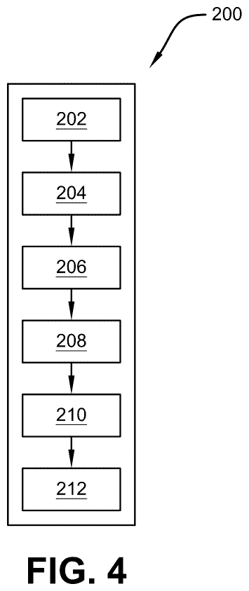

The present invention is also comprised of a method of using 200 the device 100, as seen in FIG. 4. First, a device 100 is provided, comprised of an inner frame 102, an outer frame 104, at least one wheel 108, at least one lid 116 attached via at least one hinge 118, at least one sensor 120, at least one battery 130, and an antimicrobial coating 114 [Step 202]. Next, a laundry bag 106 is placed inside the outer frame 104, wherein the laundry bag 106 may have a raised lip 109 that sits atop the outer frame 104 to secure the bag 106 in place [Step 204]. Then, when a user approaches the device 100, at least one sensor 120 detects motion or foot activation and automatically opens the lid 116 via the motorized hinge 118 [Step 206]. Afterward, soiled linens are placed into the laundry bag 106 secured by the outer frame 104. The second sensor 124 on the bottom surface 122 of the lid 116 ensures that the lid 116 remains open while laundry is being loaded [Step 208]. Once the user steps away, the lid 116 gently and quietly closes via the motorized hinge 118, preventing contamination and ensuring a hands-free operation [Step 210]. When the laundry bag 106 is full, the outer frame 104 may be manually slid or articulated to provide easy access for removal [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein, “touch-free laundry bin device” and “device” are interchangeable and refer to the touch-free laundry bin device 100 of the present invention.

Notwithstanding the foregoing, the touch-free laundry bin device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the touch-free laundry bin device 100, as shown in the FIGS. are for illustrative purposes only, and that many other sizes and shapes of the touch-free laundry bin device 100 are well within the scope of the present disclosure. Although the dimensions of the touch-free laundry bin device 100 are important design parameters for user convenience, the touch-free laundry bin device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A touch-free laundry bin device comprising:
an inner frame;
an outer frame attached to the inner frame, the outer frame comprised of a wheel and a handle;
a laundry bag received by the outer frame;
a lid attached to the outer frame via a hinge;
a first sensor configured to detect a presence of a user and trigger an opening of the lid;
a second sensor positioned on a bottom surface of the lid, the second sensor configured to keep the lid in an open position; and
a battery.

2. The touch-free laundry bin device of claim 1, wherein the wheel is comprised of a locking caster wheel.

3. The touch-free laundry bin device of claim 1, wherein the wheel is comprised of a non-marking tread.

4. The touch-free laundry bin device of claim 1, wherein the handle is comprised of a grip area.

5. The touch-free laundry bin device of claim 4, wherein the grip area is comprised of a texture.

6. The touch-free laundry bin device of claim 1, wherein the hinge is comprised of a motorized hinge.

7. The touch-free laundry bin device of claim 1, wherein the first sensor is comprised of a motion sensor, an infrared proximity sensor, a capacitive touch sensor, or a pressure sensor.

8. The touch-free laundry bin device of claim 1, wherein the second sensor is comprised of a motion sensor or an ultrasonic sensor.

9. A touch-free laundry bin device comprising:
an inner frame;
an outer frame movably attached to the inner frame, the outer frame comprised of a wheel and a handle;
a paper towel holder;
a laundry bag received by the outer frame;
a lid attached to the outer frame via a hinge;
a first sensor configured to detect a presence of a user and trigger an opening of the lid;
a second sensor positioned on a bottom surface of the lid, the second sensor configured to keep the lid in an open position; and
a battery.

10. The touch-free laundry bin device of claim 9, wherein the hinge is comprised of a motorized hinge.

11. The touch-free laundry bin device of claim 9, wherein the first sensor is comprised of a motion sensor, an infrared proximity sensor, a capacitive touch sensor, or a pressure sensor.

12. The touch-free laundry bin device of claim 9, wherein the second sensor is comprised of a motion sensor or an ultrasonic sensor.

13. The touch-free laundry bin device of claim 9, wherein the battery is comprised of a charging port.

14. The touch-free laundry bin device of claim 13, wherein the charging port is comprised of a waterproof cover.

15. The touch-free laundry bin device of claim 9 further comprised of a battery status indicator.

16. The touch-free laundry bin device of claim 9, wherein the wheel is comprised of a locking caster wheel.

17. The touch-free laundry bin device of claim 9, wherein the wheel is comprised of a non-marking tread.

18. The touch-free laundry bin device of claim 9, wherein the handle is comprised of a grip area.

19. The touch-free laundry bin device of claim 18, wherein the grip area is comprised of a texture.

20. A method of using a touch-free laundry bin device, the method comprising the following steps:
providing a touch-free laundry bin device comprised of an inner frame, an outer frame attached to the inner frame, a wheel, a lid attached to the inner frame via a hinge, a sensor, and a battery;
placing a laundry bag inside the outer frame;
approaching the touch-free laundry bin device, wherein the lid automatically opens upon approach; and
loading a linen into the laundry bag while the lid remains in an open position.
